(19) United States
(12) Patent Application Publication
(10) Pub. No.: US 2022/0347950 A1
(43) Pub. Date: Nov. 3, 2022

(54) INJECTOR AND SUPPORT DEVICE FOR REPAIRING LAMINATED GLASS

(71) Applicant: DB IMAGINEERING B.V., OISTERWIJK (NL)

(72) Inventor: Johannes Wilhelmus Maria SCHELLEKENS, OISTERIJK (NL)

(21) Appl. No.: 17/334,004

(22) Filed: May 28, 2021

(30) Foreign Application Priority Data
Apr. 30, 2021 (EP) EP 21075003.0

(51) Int. Cl. B29C 73/16

(52) U.S. Cl. CPC B29C 73/166

(57) ABSTRACT

A plate glass repair tool has two casing members rotatably connected to one another, one of the two casing members having a screw thread defining a helical groove. The screw thread has a pitch varying in a direction from a distal end to an opposite end of the tool, an angle of inclination of the screw thread with respect to a transverse plane increasing continuously in the direction from the one end to the opposite end, a camming element extending from the other of the two casing members into the helical groove. The two casing members each comprise a cylindrical body, the cylindrical body of the other of the two casing members being disposed about the cylindrical body of the one of the two casing members.

### FIELD OF THE INVENTION

The present invention concerns a tool for repairing laminated glass panes, mostly automobile windshields, to fill in cracks, pits, and similar damaged areas. The tool functions to inject resin into the cracks and to remove air bubbles from the injected or deposited resin.

### BACKGROUND OF THE INVENTION

The state of the art includes various windshield glass repair tools such as that described in US Patent Application Publication No. US2019/0016071 A1 filed Jan. 17, 2019 and entitled “Windshield and Laminated Glass Repair Tool.” The glass repair tool of that patent publication functions to inject resin into defects in glass. The tool is removably engageable with the glass pane and is disposable in sliding ratcheted engagement with a center portion of a cooperating support device to press the tool into engagement with the glass pane. However in practice there are more drawbacks in the structure of this injector. The repair tool has a very thin driving axle with a small constant pitch to move the piston to inject the crack with resin in the pane. Then the piston has to rotate and axial move in the cylinder, friction being generated by the rotational movement. Then the resin chamber is directly under the piston and so the injection tube has to be placed firmly against the windshield, which can lead to further damage to the windshield. Moreover, the unscrewing of the driving axle and the movement of the piston away from the windshield surface during an air bubble extraction procedure creates a vacuum force drawing the piston and axle back toward the windshield. Thus there is a need for a locking element. Also there is a problem in placing the tube with its resin injection mouth exactly above the damage in the windshield and to stabilize the injector. So there are several drawbacks in practice using described injection tool.

The state of the art further includes U.S. Pat. No. 5,670,180 filed Apr. 5, 1996 and issued Sep. 23, 1997 entitled “Laminated Glass and Windshield Repair Device.” This patent discloses a device to repair bulls-eye type cracks and elongate cracks in laminated glass. The repair device includes a piston in a cylinder and is driven by a relatively small diameter axle with a corresponding screw thread.

This repair device has the same drawbacks as the device of the other patent discussed above. The self-locking of the spindle and the piston is executed with a locking-screw (48) in a groove with a very small diameter. In practice this repair device is not very easy to handle.

Dutch Patent Application No. NL1042482 filed Jul. 26, 2017 and entitled “Instrument or Device for Removing Air Out of Repair Resins in Laminated Glass” discloses a device only for removing air bubbles in repair resins in bulls-eye fractures in laminated glass. The drawback of this invention is that the device is not usable for the combination functionality of injecting repair resin and removing air bubbles in practice.

### Object of the Invention

The aim of the invention is to overcome the above-mentioned drawbacks and to provide a repair injector for use with a known support device for repairing laminated glass panes, particularly automobile windshields. Preferably, the repair injector of the present invention operates efficiently and can be manufactured at relatively low costs.

### SUMMARY OF THE INVENTION

A resin-injector and air-bubble-extraction tool (“injector tool” or “injector”) for repairing automobile windshields comprises, in accordance with the invention, a first cylindrical casing that houses a piston assembly movable only in a longitudinal or axial direction (not angularly or rotationally) relative to the casing for dispensing resin material and for extracting air bubbles from the resin upon deposition thereof in a crack or pit in a laminated glass pane such as an automobile windshield. A first or inner casing of the injector has a two-step or staggered structure with an injection tube, forming a lower or distal casing portion having an outer thread diameter D1, for connecting to a support device or frame typically having suction cups for fixation to a windshield. This first casing has an upper or proximal tube part, i.e., a cylindrical main body member, provided with an outer screw thread of diameter D2 and an associated helical groove, wherein diameter D1 is substantially less than diameter D2. The injector has a second cylindrical casing rotatably mounted about (surrounding) the first cylindrical casing and provided with an internal steel camming element projecting into and sliding in the outer helical groove on the cylindrical main body member of the first cylindrical casing. The second (outer, rotating) cylindrical casing has approximately the same (but slightly larger) outer diameter D2 as the first cylindrical casing for moving the piston alternately in a distal or injection direction and a proximal or extraction direction. An injection/extraction tubular or nose piece or distal end portion is provided at a free end with an annular flexible seal element. The construction material of the tool a light weight material such as aluminum.

A repair injector in accordance with the present invention is configured for mounting to or placement in a known support device, particularly a tripod support with rubber suction cups for fixing on a windshield and with an extension strip for mounting the repair injector by screwing the nose piece or distal end portion of the main casing in a bore.

A glass-pane repair resin injector mountable to a laminated glass pane by means of a suction-grip support device comprises, in accordance with the present invention, a first cylindrical casing, a central pin, a piston, and a second cylindrical casing. The first cylindrical casing includes a tubular distal end portion having a longitudinal axis and a free distal end engageable with a laminated glass pane at a crack. The tubular distal end portion has a first outer screw thread with a first diameter for coupling the repair injector to the suction-grip support device. The first cylindrical casing further includes a main body portion with an outer diameter substantially larger than an outer diameter of the tubular distal end portion. The main body portion has a second outer screw thread with a second diameter defining a helical camming groove, the second diameter being substantially larger than the first diameter. The central pin is disposed in the first cylindrical casing for motion (a) in a distal direction parallel to or along the longitudinal axis so as to insert into the tubular distal end portion and to eject resin through an opening or mouth at the free end of the tubular distal end portion and to deposit the resin into the crack in the laminated glass pane and alternately (b) in a proximal direction along the longitudinal axis for extracting air bubbles out of the deposited resin. The piston is disposed in the first cylindrical casing for movement only axially relative thereto, the central pin being rigidly connected to the piston on a distal side thereof. The second cylindrical casing is disposed around and radially outwardly of the first cylindrical casing for rotation relative thereto. The second cylindrical casing has a cylindrical inner surface with a diameter larger than the outer diameter of the first cylindrical casing and is provided with a camming element projecting into the helical camming groove. The second cylindrical casing is connected to the piston for shifting same in the distal direction and alternately in the proximal direction along the longitudinal axis and relative to first cylindrical casing. The second outer screw thread preferably has a continuously varying pitch that increases from a minimum at a distal end to a maximum at a proximal end.

An advantage of the injector tool as described above is that only the outer cylindrical casing is turned by hand around the longitudinal axis of the tool and because of the bigger diameter D2 a very precise moving of the central pin is possible. So a very professional result in repairing laminated glass panes (vertical windshields) is possible.

The helical camming groove has a maximum angle of 7.853 degrees with respect to a transverse plane perpendicular to the longitudinal axis or the injector tool, common to the first casing and the second casing, whereby the first and the second cylindrical casing arrest or lock to one another at all rotational positions owing in part to a minimum friction coefficient of 0.25 between steel of the camming element and aluminum of the casings.

In a preferred embodiment, the first diameter, that of the tubular nose or distal end portion of the first casing is about 8 mm and the outer screw thread of the tubular nose or distal end portion has a pitch of 3 mm, while the second diameter, of the main portion of the first casing is about 30 mm. The second outer screw thread has a pitch increasing from about 3 mm to about 13 mm from a distal end to a proximal end.

In the preferred embodiment, surfaces of the first cylindrical casing and the second cylindrical casing are anodized.

A plate glass repair tool in accordance with the present invention comprises a first casing, a second casing and a piston assembly. The first casing includes a tubular nose or distal end portion with a cylindrical outer surface having a first screw thread. The first casing further includes a main body portion with a cylindrical first surface having a first longitudinal axis of symmetry. The cylindrical first surface, of the main body portion, has a diameter substantially larger than a diameter of the cylindrical outer surface of the tubular nose or distal end portion. The second casing has a cylindrical second surface with a second longitudinal axis of symmetry. One of the cylindrical first surface, of the first casing, and the cylindrical second surface, of the second casing, has a second screw thread defining a helical groove, while the other of the cylindrical first surface and the cylindrical second surface has a lug projecting away from that surface. The second casing and the main body portion of the first casing are inserted at least partially one inside the other so that (i) the first longitudinal axis and the second longitudinal axis coincide and constitute a common axis, (ii) the lug is slidably disposed within the groove, and (iii) the second casing is freely rotatable about the first longitudinal axis relative to the first casing and is simultaneously movable longitudinally with respect to the first casing. The piston assembly is disposed within the first casing and the second casing. The piston assembly is provided with a perimeter seal in sliding engagement with an inner surface of the main body portion of the first casing. The piston assembly is axially fixed and rotatably connected to an end of the second casing opposite the first casing, whereby rotation of the second casing relative to the first casing shifts the second casing and the piston assembly longitudinally along the first (common) axis relative to the first casing by virtue of the lug exerting a camming force on the second screw thread. The second screw thread has a pitch that increases, preferably continuously or monotonically, in a direction extending away from the tubular nose or distal end portion of the first casing.

Pursuant to another feature of the invention, the second screw thread has an angle relative to a transverse plane (oriented perpendicularly to the common longitudinal axis of the casings) that varies from 1.823 degrees at one end to 7.853 degrees at an end opposite the tubular nose portion of the first casing.

Where the piston assembly includes a disk, the perimeter seal is mounted to the disk, and the piston assembly further includes a pin extending axially from the disk, the pin being at least partially insertable into the tubular nose portion to eject resin material from an opening or mouth at a free end of the tubular nose portion.

Preferably, the cylindrical first surface is an outer surface of the main body portion of the first casing, while the cylindrical second surface is an inner surface of the second casing. Thus the main body portion of the first casing is insertable to a variable extent inside the second casing.

The tubular nose portion is provided at a free or distal end with an annular flexible element for forming a seal with a glass surface. The diameter of the main body portion and concomitantly of the cylindrical first surface is between 1.5 and 3 times as large as the diameter of the cylindrical outer surface of the tubular nose portion.

In brief, a plate glass repair tool in accordance with the invention comprises two casing members rotatably connected to one another, one of the two casing members having a screw thread defining a helical groove and having a pitch varying in a direction from a distal end to an opposite end of the tool. An angle of inclination of the screw thread with respect to a transverse plane perpendicular to a common longitudinal axis of the two casing members increases continuously in the direction from the one end to the opposite end of the screw thread. A camming element extends from the other of the two casing members into the helical groove. The two casing members each comprise a cylindrical body, the cylindrical body of the other of the two casing members being disposed about the cylindrical body of the one of said two casing members.

A repair injector in accordance with the present invention in practice is easy to handle with a great accuracy and produces repair quality at a high standard. The injector may be flexibly placed and moved for inspection over the windshield mounted in the support device.

Furthermore a repair injector according to the invention is further developed with the characteristics that the first cylindrical casing with diameters D1 and D2 has an internal assembly existing of a piston that is only translatable along and not rotatable about the longitudinal axis of the injector, the piston provided at an underside (distal side) with an axial pin moving in the tubular lower or distal end part to inject the repair resin and to retract air bubbles out of the deposited repair resin, the piston being further provided at an upper or proximal side with an axle supported in a circular bearing in an internal upper or proximal end of the second, rotating, cylindrical casing.

A repair injector according to the invention is preferably made mainly of aluminium. The consequent light weight facilitates handling and is less likely to cause breaking of a seal between the tool and a glass surface under repair. Other features of the invention further contribute to ease of handling and maintenance of the seal. The advantage is especially significant in the repair of mainly vertical or upright automobile windshields. The lower the weight (and the less the lever arm between the user's grip on the tool and the windshield) the better the skilled craftsman can undertake the repair and additionally the costs are lower.

As disclosed herein, a repair injector according to the invention exhibits a maximum angle beta (β) of the helical groove of 7.853 degrees relative to a transverse plane and a minimum friction coefficient, gamma, of 0.25 of steel (steel cam 6) on aluminium, in a force diagram a friction angle (γ) of 14 degrees, so that angle γ>angle β and the repair injector is in all positions self-locking. Where the helical (camming) thread has an outer diameter D2 of 30 mm, the pitch of the thread increases from 3 mm at one end to 13 mm at an opposite end. The advantage is tool stability in all phases of a repair job, which makes the tool easier to use for the skilled craftsman.

A repair injector according to the invention has a distally extending tubular nose piece or end portion with a threaded external diameter D1 of 8 mm and a pitch of 3 mm under a central angle alpha (α) with the axis of the repair injector of 6.807 degrees. The advantages are a normal screwing of the repair injector into a conventional suction-mounted support device and an adjusting of the injector pin from fine to coarse. This is an extra possibility for the skilled craftsman.

Where the repair injector is anodized with a coating, the injector has an attractive exterior and protection against corrosion.

### BRIEF DESCRIPTION OF THE DRAWING

A preferred embodiment of the present invention will now be described with reference to the accompanying drawing, in which:

FIG. 1A shows an axial section, taken along line 1A-1A in FIG. 1B, of a repair injector in accordance with the present invention, showing the injector tool in a starting or most extended configuration for a resin injection phase of a glass plate repair procedure;

FIG. 1B shows a side view of the repair injector in the position of FIG. 1A;

FIG. 2A shows an axial section, taken along line IIA-IIA in FIG. 2B, of the repair injector in a finishing position of the resin injection phase and a starting position of an air bubble extraction phase of a repair procedure;

FIG. 2B shows a side view of the repair injector in the position of FIG. 2A;

FIG. 3A shows a side view of a known support device with the repair injector of FIGS. 1A, 1B, 2A and 2B mounted thereto and shown in an axial section taken along line IIIA-IIIA in FIG. 3B; and

FIG. 3B shows a side view of the support device with the mounted or screwed repair injector of FIG. 3A.

### DEFINITIONS

The word “distal” is used herein to denote the end of the injector-extractor tool that contacts a glass surface during use of the tool. Concomitantly, the term “distal direction” and the word “distally” when applied to movement of a part of the tool mean movement towards the distal end of the tool.

The word “proximal” is used herein to denote the end of the injector-extractor tool that is closer to the user and opposite the distal end of the tool. Concomitantly, the term “proximal direction” and the word “proximally” when applied to movement of a part of the tool mean movement away from the distal end of the tool.

The inclination angle of a screw thread denotes the angle of the thread, and also of the groove defined by the thread, relative to a transverse plane oriented perpendicularly to the longitudinal axis of a cylindrical surface, axle or wall on which the thread is disposed.

The word “crack” is used herein to generically designate various kinds of damage to laminated glass panes or plates, including pits, recesses with shapes of stars or bulls eyes, extending linear and branching cracks, etc.

The word “substantial” or “substantially” is used herein in a comparison of dimensions means a difference of about 50% or more, as opposed to an insubstantial difference on the order of a few percent. With respect to the diameter of a cylindrical casing element relative to a tubular nose portion thereof, the term contemplates a diameter difference factor of at least 1.5 to 3

### DETAILED DESCRIPTION

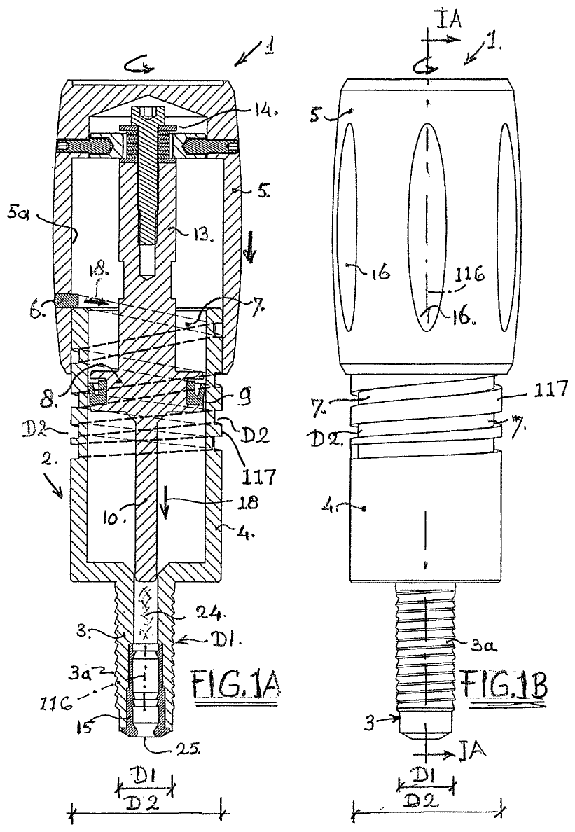

FIGS. 1A and 1B show an axial cross section and a side view of a glass repair tool 1, particularly a resin injector and air bubble extractor tool. As depicted in FIG. 1A, the repair injector-extractor tool 1 (herein “injector tool 1”) includes an inner, central, first cylindrical casing 2 having a two-stepped configuration with (a) a tubular nose or distal end portion 3 having an outer screw diameter D1 and (b) a main body or piston casing portion 4 with a helical screw thread 117 defining a helical groove 7 and having an outer thread diameter D2. Casing 2 is made of aluminum because of the light weight.

As further depicted in FIGS. 1A and 1B, injector tool 1 further includes an outer second cylindrical casing 5 made of aluminum and rotatably mounted to and partially surrounding the first cylindrical casing 2. A user can manually turn the outer cylindrical casing 5 about a common longitudinal axis 116 (FIG. 1B) of casings 2 and 5.

A steel camming element or lug 6 rigidly attached to outer casing 5 projects inwardly into helical groove 7 of inner casing 2. During rotation of outer casing 5, camming element 5 slides against helical thread 117 causing the outer casing to move axially along longitudinal axis 116 with respect to inner casing 2. Depending on the direction of rotation of outer casing 5 relative to inner casing 2 and particularly main body portion 4 thereof, casing 5 moves in a distal direction towards tubular distal end portion 3 or in a proximal direction away from tubular distal end portion 3. The user rotates outer casing 5 to move the same in the distal direction during a resin injection phase of a glass pane repair procedure. Conversely, the user rotates outer casing 5 to move it in the proximal direction during an air-bubble evacuation or extraction phase of the repair procedure.

A piston 8 with a perimeter or O-ring rubber seal 9 is disposed inside inner casing main-body portion 4 with the O-ring rubber seal in air-tight contact with an inner surface (not designated) of the main body portion 4 of inner casing 2. Injector 1 is configured so that piston 8 is movable only in the axial or longitudinal direction and does not rotate in an angular direction about longitudinal axis 116. Consequently friction is reduced, which means less effort is required on the part of the user. Less effort means easier concentration and control or the tool, particularly in maintaining a seal of the tool against the glass pane surface at a repair site.

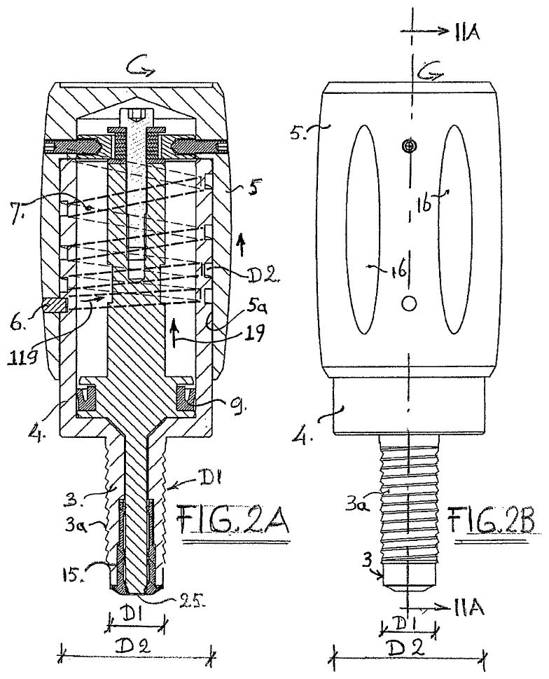

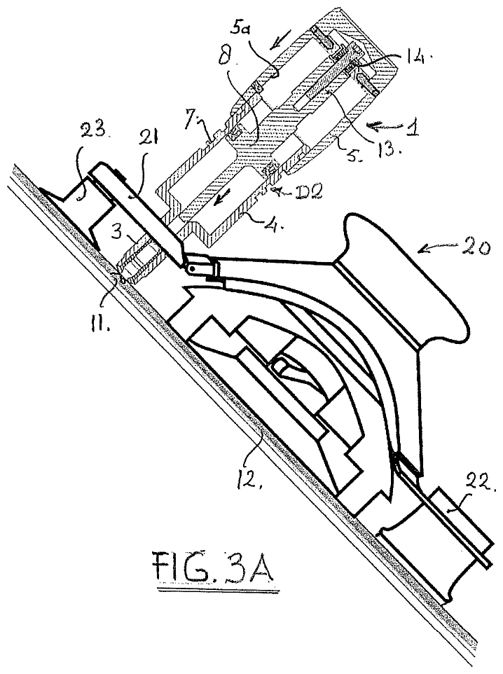

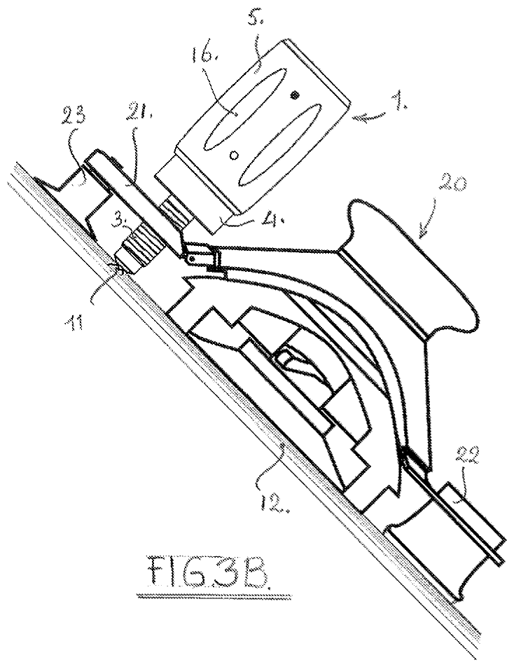

Piston 8 has an axial injection/retraction pin 10 projecting axially in the distal direction for driving repair resin 24, preloaded into tubular nose or distal end portion 3 (FIG. 1A), from distal end portion 3 through a mouth or opening 25 (FIGS. 1A and 2A) at a free end thereof into a crack 11 or the damage point of a windshield 12 and retract the air bubbles out of the injected resin. See FIGS. 3A and 3B. In addition, piston 8 is provided with a top axle 13, which has a proximal end (not designated) placed in a central bearing construction 14. Thus piston 8 is fixed to outer casing 5 for distal and proximal translatory motion along longitudinal axis 116 but is rotatable relative to the outer casing. Thus rotation of outer casing 5 during a repair procedure results in axial motion but not rotary motion of piston 8 relative to inner or main casing 2.

The motion of piston 8 moves injection/retraction pin 10 alternatively in the distal direction towards and in a proximal direction away from windshield 12. At a free end (not separately designated), tubular distal end portion 3 is provided with an annular cylindrical rubber element 15 that flexibly contacts windshield 12 and seals the free end of tubular distal end portion 3 against the windshield during both a resin injection phase and an air bubble extraction a glass-pane repair procedure or operation.

As illustrated in FIGS. 1A, 2A and 3A, helical thread 117 (and also groove 7) has a pitch or turn-separation that increases continuously or monotonically from a distal side to a proximal side of injector tool 1. More specifically, screw thread 117 has an angle β relative to a transverse plane perpendicular to longitudinal axis 116 that varies from 1.823 degrees at the distal end to 7.853 degrees at the proximal end, opposite tubular nose or distal end portion 3 of inner casing 2. Concomitantly, thread 117 and groove 7 have a slope that varies from 0.031830989 to 0.137934284. The maximum inclination angle of 7.853 degrees and the associated slope of 0.137934284 ensure that the composite friction between outer casing 5 and inner casing 2, particularly including the friction of steel camming element 6 against thread 117, is sufficiently great at all points along the thread to frictionally lock the casings 5 and 2 to one another especially during an entire air bubble extraction phase of the repair procedure.

Helical groove 7 accurately guides steel cam 6 as described. For easy rotating by hand outer cylindrical casing 5 is provided on an outer surface (not separately designated) with elliptical recesses 16 oriented longitudinally, as shown in FIGS. 1B, 2B and 3B. In the different figures, the same elements are indicated with the same reference numerals. In FIG. 1A piston 8 is moving downwards or distally as indicated with an arrow 18 while in FIG. 2A piston moves upwardly or proximally as indicated by an arrow 19.

FIGS. 3A and 3B illustrate injector tool 1 attached to windshield 12 via a known or conventional support device 20 having rubber suction cups 22 and 23. A rotatable extension strip is indicated with 21.

The injector-extractor tool 1 disclosed herein facilitates the repair of laminated glass panes such as windshield 12 by making the tool easier to handle particularly in the extraction of air bubbles. Not only is injector tool 1 lightweight owing to the aluminum material of the casings 2 and 5 but also the placement of the rotatable casing 5 outside of the piston or main casing 2, which enables a gripping and turning of rotatable outer casing 5 at a location closer to tubular nose or distal end portion 3 and thus closer to the window pane or windshield 12 being repaired. The reduction of the distance between the user's hand and the point of contact of tool 1 with the glass surface reduces a lever arm of the tool at the glass surface, thereby minimizing inadvertent applications of torque by the user that might break the seal between the tool and the glass and interrupt the extraction of air bubbles from the deposited resin.

In addition, the varying pitch of screw thread 117 provides for a differential rate of bubble extraction per turn of the rotatable casing 5 relative to the main body casing 2, that maintains air pressure within the main body casing at an approximately constant and slight underpressure. The varying thread pitch up to a predetermined maximum pitch (and angle of inclination or slope) pursuant to the present invention enables a friction lock at all degrees of separation of the two casings 2 and 5 during the air bubble extraction phase of a repair operation.

After the resin has been injected into the crack 11 in the laminated glass pane or windshield 12, an initial turning of the rotatable casing 5 relative to the main body casing 2 pulls bubbles from an outer surface region of the deposited resin and extracts the air of those bubbles first, drawing the air into the main casing 2. Very little movement of piston 8 is required for the removal of the superficial air bubbles, and thus the small angle or inclination (or slope) of the thread 117 at the distal end. Later in the extraction phase, deeper air bubbles are drawn towards the surface of the resin. Removal of the deeper bubbles requires a greater rate of separation of the two casings 2 and 5 in part owing to the deeper location of the bubbles but also owing to the greater volume of air in the main casing 2. The movement of outer casing 5 relative to inner, main, casing 2 is faster to exert sufficient vacuum force for air extraction owing to the greater volume of air in the main casing. The result is that the injector-extractor tool 1 pulls air into the main casing 2 and limits the suction force tending to drawing the two casings together during the air extraction phase of the repair operation.

The varying pitch of screw thread 117 also facilitates resin injection. At the beginning of injection, the resin is easy to move through the tubular distal end portion 3 of the main casing 2 and into the crack 11 in the windshield 12. The large pitch region of screw thread 117 at the proximal end thereof, with its concomitantly large inclination angle and large slope, is suited to this initial ease of injection. Later, when the resin is compacting within the crack 11, a reduced pitch enables a slower rate of movement of the resin into the crack and a slower increase in applied pressure adapted to the increasing confinement of the ejected resin within the crack.

The friction locking of rotatable outer casing 5 relative to main casing 2 during air bubble extraction means that the user does not need to maintain a firm grip on the rotatable casing as in prior art tools where the vacuum pressure pulls the piston constantly into the respective casing. The difficulty in maintaining a proper grip during a turning procedure increases the likelihood of an inadvertent break in the tool-glass seal and a consequent failure of the process.

The self-locking property of outer casing 5 to inner casing 2, accurate adjustability of piston 8, a low pressure exerted on windshield 12 by cylindrical annular flexible sealing 15, the simplified operation by hand and relatively low manufacture costs are the most important properties of injector tool. However it is obvious that modifications and/or additions can be made, but these shall remain within the scope and field of the invention. One such modification may be a disposition of the rotatable casing 5 within the main casing 2 rather that outside the same. Another modification may be a disposition of screw thread 117 on rotatable casing 5 and an attachment of camming element 6 to inner casing 2. A further embodiment would be to incorporate both these modifications in the same tool.

1. A glass-pane repair resin injector tool mountable to a laminated glass pane by means of a suction-grip support device, comprising:
a first cylindrical casing with a tubular distal end portion having a free distal end engageable with a laminated glass pane at a crack, said first cylindrical casing having a longitudinal axis, said tubular distal end portion having a first outer screw thread with a first diameter for coupling the repair injector to the suction-grip support device, said first cylindrical casing having a main body portion with an outer diameter substantially larger than an outer diameter of said tubular distal end portion, said main body portion having a second outer screw thread with a second diameter defining a helical camming groove, said second diameter being substantially larger than said first diameter;
a central pin disposed in said first cylindrical casing for motion (a) in a distal direction parallel to or along said longitudinal axis so as to insert into said tubular distal end portion for ejecting resin through an opening or mouth at the free end of said tubular distal end portion and depositing resin into the crack in the laminated glass pane and alternately (b) in a proximal direction along said longitudinal axis for extracting air bubbles out of the deposited resin;
a piston disposed in said first cylindrical casing for movement only axially relative thereto, said central pin being rigidly connected to said piston on a distal side thereof; and
a second cylindrical casing disposed around and radially outwardly of said first cylindrical casing for rotation relative thereto, said second cylindrical casing having a camming element projecting into said helical camming groove, said second cylindrical casing having a cylindrical inner surface with a diameter larger than the outer diameter of said first cylindrical casing,
said second cylindrical casing being connected to said piston for shifting same in said distal direction and alternately in said proximal direction along said longitudinal axis and relative to first cylindrical casing.

2. The glass-pane repair resin injector tool as defined in claim 1, wherein said second outer screw thread has a continuously varying pitch that increases from a minimum at a distal end to a maximum at a proximal end.

3. The glass-pane repair resin injector tool as defined in claim 2, wherein said first cylindrical casing and said second cylindrical casing are made of aluminium, said camming element being made of steel.

4. The glass-pane repair resin injector tool as defined in claim 3, wherein the helical camming groove has a maximum angle of 7.853 degrees with respect to a transverse plane perpendicular to said longitudinal axis.

5. The glass-pane repair resin injector tool as defined in claim 1, wherein said first diameter is about 8 mm and said first outer screw thread has a pitch of 3 mm and wherein said second diameter is about 30 mm, said second outer screw thread having a pitch increasing from about 3 mm to about 13 mm from a distal end to a proximal end.

6. The glass-pane repair resin injector tool as defined in claim 1, wherein surfaces of said first cylindrical casing and said second cylindrical casing are anodized.

7. The glass-pane repair resin injector tool as defined in claim 1 wherein said second outer screw thread has a pitch that varies from one end to another end, said pitch having a smaller value on a distal side than on a proximal side.

8. A windshield repair assembly including the glass-pane repair resin injector tool as defined in claim 1, further comprising a support device comprising a tripod frame with rubber suction cups attachable to a windshield further comprising an extension strip with a bore receiving said tubular distal end portion.

9. A resin-injecting plate glass repair tool comprising:
a first cylindrical casing including a tubular nose portion with a cylindrical outer surface having a first screw thread, said first cylindrical casing further including a main body portion with a cylindrical first surface symmetrical about a longitudinal axis, said cylindrical first surface having a diameter larger than a diameter of said cylindrical outer surface;
a second cylindrical casing having a cylindrical second surface symmetrical about said longitudinal axis, one of said cylindrical first surface and said cylindrical second surface having a second screw thread defining a helical groove, the other of said cylindrical first surface and said cylindrical second surface having a lug projecting away from said other of said cylindrical first surface and said cylindrical second surface, said main body portion of said first cylindrical casing being inserted at least partially inside said second cylindrical casing so that said lug is slidably disposed within said groove, and said second cylindrical casing is freely rotatable about said longitudinal axis relative to said first cylindrical casing and is simultaneously movable longitudinally with respect to said first cylindrical casing; and
a piston assembly disposed within said first cylindrical casing and said second cylindrical casing, said piston assembly having a perimeter seal in sliding engagement with an inner surface of said main body portion of said first cylindrical casing, said piston assembly being axially fixed and rotatably connected to an end of said second cylindrical casing opposite said first cylindrical casing, whereby rotation of said second cylindrical casing relative to said first cylindrical casing shifts said second cylindrical casing and said piston assembly longitudinally along said first longitudinal axis relative to said first cylindrical casing by virtue of said lug exerting a camming force on said second screw thread,
wherein said second screw thread has a pitch that increases in a direction extending away from said tubular nose portion.

10. The resin-injecting plate glass repair tool defined in claim 9 wherein the pitch of said second screw thread increases monotonically and gradually.

11. The resin-injecting plate glass repair tool defined in claim 10 wherein said second screw thread has an angle relative to a transverse plane perpendicular to said first longitudinal axis that varies from 1.823 degrees at one end to 7.853 degrees at an end opposite said tubular nose portion of said first cylindrical casing.

12. The resin-injecting plate glass repair tool defined in claim 9 wherein said first cylindrical casing and said second cylindrical casing are made of aluminum and said lug is made of stainless steel.

13. The resin-injecting plate glass repair tool defined in claim 9 wherein said piston assembly includes a disk, said perimeter seal being mounted to said disk, said piston assembly further including a pin extending axially from said disk, said pin being at least partially insertable into said tubular nose portion to eject resin material from an opening or mouth at a free end of said tubular nose portion.

14. The resin-injecting plate glass repair tool defined in claim 9 wherein said cylindrical first surface is an outer surface of said main body portion of said first cylindrical casing, said cylindrical second surface is an inner surface of said second cylindrical casing, said main body portion of said first cylindrical casing being insertable to a variable extent inside said second cylindrical casing.

15. The resin-injecting plate glass repair tool defined in claim 9 wherein said tubular nose portion is provided at a free or distal end with an annular flexible element for forming a seal with a glass surface.

16. The resin-injecting plate glass repair tool defined in claim 9 wherein the diameter of said cylindrical first surface is between 1.5 and 3 times as large as the diameter of said cylindrical outer surface.

17. A resin-injecting plate glass repair tool comprising two cylindrical casing members rotatably connected to one another, one of said two cylindrical casing members having a screw thread defining a helical groove and having a pitch varying in a direction from a distal end to an opposite end of the tool, an angle of inclination of the screw thread with respect to a transverse plane perpendicular to a common longitudinal axis of said two cylindrical casing members increasing continuously in said direction from said one end to said opposite end, a camming element extending from the other of said two cylindrical casing members into said helical groove, a first of said two cylindrical casing members having a main body and a tubular distal end portion, a second of said two cylindrical casing members being disposed about said main body of said first of said two cylindrical casing members so that said two cylindrical casing members are relatively rotatable and relatively translatable parallel to said common longitudinal axis.

18. (canceled)
